(19) United States
(12) Patent Application Publication
(10) Pub. No.: US 2015/0030496 A1
(43) Pub. Date: Jan. 29, 2015

(54) ALUMINUM ALLOY WIRE AND WIRE ASSEMBLY PARTS

(71) Applicant: M&C Corporation, Sterling Heights, MI (US)

(72) Inventors: Ronald Daniel MCLEOD, Midhurst, CA (US); Stephen Alan Moore, Barrie, CA (US)

(73) Assignee: M&C Corporation, Sterling Heights, MI (US)

(21) Appl. No.: 13/952,051

(22) Filed: Jul. 26, 2013

(51) Int. Cl. C22C 21/08; B62D 29/00

(52) U.S. Cl. CPC C22C 21/08; B62D 29/008
USPC 420/532

(57) ABSTRACT

Vehicle parts, and more particularly wire and wire assembly parts, manufactured from a non-heat-treatable, wrought aluminum alloy are disclosed. The wire and wire assembly parts are shaped into different forms that meet certain strength and bendability requirements and are capable of being manufactured using forming, threading and swaging. The aluminum alloy used to manufacture the parts is a non-heat-treatable, wrought alloy formed predominantly from aluminum (Al) metal, which is alloyed primarily with magnesium (Mg), and which also includes silicon (Si), iron (Fe), copper (Cu), manganese (Mn), chromium (Cr), zinc (Zn), titanium (Ti), beryllium (Be) and other elements.

The present invention relates to vehicle parts, and more particularly to wire and wire assembly parts manufactured using an aluminum alloy composition.

### BACKGROUND OF THE INVENTION

The Corporate Average Fuel Economy (CAFE) are regulations promulgated in the United States for improving the average fuel economy of cars and light trucks (which include vans and sport utility vehicles) sold in the U.S. Historically, a manufacturer's CAFE is the sales-weighted harmonic mean fuel economy, expressed in miles per U.S. gallon (mpg), of a manufacturer's fleet of current model year passenger cars and light trucks with a gross vehicle weight rating (GVWR) of 8,500 pounds (3,856 kg) or less, manufactured for sale in the United States. If the average fuel economy of a manufacturer's annual fleet of vehicle production falls below the defined standard, the manufacturer must pay a penalty equal to a specified U.S. dollar amount per 0.1 mpg under the standard, multiplied by the manufacturer's total production for the U.S. domestic market.

Recently, the automotive industry has been challenged to improve their CAFE requirements from a current fuel economy of 26 mpg to one of 52 mpg by the year 2026. There are a number approaches which can help accomplish this goal, but the primary means that will likely be used will be to reduce the weight of automobiles. To that it would be desirable to develop a lightweight material that can be formed by automotive part forming equipment and be able to satisfy the strength requirements of specified automotive parts.

In this regard, cars, trucks, vans and sport utility vehicles typically include as part of their construction various wire and wire assembly parts having different shapes and forms. These parts can include, for example, door lock and release rods, hood support rods, seat belt guides, battery hold down rods, engine support and guide wires, exhaust hangers, seat support, seat adjustment and seat structure wires.

For many wire part applications the parts to be used must include sharp bends to fit properly within a given environment or application, and they must also include special end treatments to allow the rods to be connected to latches and connecting mechanisms. These parts must also meet certain strength requirements typically specified by a manufacturer to ensure that they will operate properly, such as, for example, a connecting rod used in a vehicle door properly actuating the door's handle and release mechanism. The rods must also be capable of being manufactured using forming, threading and swaging.

The current best practice in automotive manufacturing of wire and wire assemblies is to use steel (typically 1008-1010 mild steel) to form the parts. Any material replacing the steel would need to be manufacturable into products having certain predefined strength, durability and corrosion resistance, and have the ability to be formed, pressed, machined, cold worked and welded.

### BRIEF DESCRIPTION OF THE INVENTION

The present invention is directed to vehicle parts manufactured from a non-heat-treatable, wrought aluminum alloy, and more particularly to wire and wire assembly parts manufactured from the alloy and shaped into different forms that meet certain predetermined strength and bendability requirements and that are capable of being manufactured using manufacturing methods, such as forming, threading and swaging. The aluminum alloy can be used to manufacture parts for automotive, marine and aerospace vehicles. The alloy is a controlled 5000 series type of aluminum alloy in which the aluminum is alloyed primarily with magnesium. One example of a 5000 series type of aluminum alloy is the 5356 alloy composition, which includes the following elements identified as a maximum percentage by weight, that is: 0.25% silicon (Si), 0.4% iron (Fe), 0.1% copper (Cu), 0.05%-0.2% manganese (Mn), 0.05%-0.2% chromium (Cr), 0.1% zinc (Zn), 0.06%-0.2% titanium (Ti), 4.5-5.5% magnesium (Mg), 0.0003% beryllium (Be), 0.15% “other” elements, with each of the other elements being no more than 0.05%, and the remainder of the alloy being aluminum (Al) as the predominant metal.

The aluminum alloy used to manufacture the vehicle parts of the present invention has been known to be used for welding together pieces of aluminum. It is a non-heat-treatable, wrought alloy formed predominantly from aluminum (Al), and includes as its alloying elements silicon (Si), iron (Fe), copper (Cu), manganese (Mn), chromium (Cr), zinc (Zn), titanium (Ti), magnesium (Mg), beryllium (Be), and other elements. Magnesium (Mg) is a percentage by weight that is less than the aluminum, but more than the remaining elements forming the aluminum alloy. Specifically, the alloy composition includes the following elements identified as a maximum percentage by weight, that is: 0.09% silicon (Si), 0.19% iron (Fe), 0.01% copper (Cu), 0.1%-0.15% manganese (Mn), 0.1%-0.13% chromium (Cr), 0.01% zinc (Zn), 0.06%-0.11% titanium (Ti), 4.8-5.05% magnesium (Mg), 0.0003% beryllium (Be), 0.1% “other” elements, with each of the other elements being no more than 0.02%, and the remainder of the alloy being aluminum (Al) as the predominant metal.

The concentration of “other” elements is typically as follows: As (Arsenic)<0.005%, Ga (Gallium)<0.01%, V (Vanadium)<0.01%, Pb (Lead)<0.001%, Ni (Nickel)<0.01%, Na (Sodium)<0.0002%, and Ca (Calcium)<0.003%. It should be noted that this concentration of “other” elements can be varied.

The vehicle parts formed from the aluminum alloy are capable of being manufactured using forming, threading and swaging. “Forming” uses stresses, like compression, tension, shear or combined stresses, to cause plastic deformation of a material to produce a required shape. “Threading” is a process of producing a screw thread. Deformative or transformative methods of producing threads include rolling and forming. “Swaging” is a process in which the dimensions of a part are altered by shaping of the aluminum alloy using compressive forces.

The aluminum alloy is also capable of being formed into parts having bends, and particularly, sharp bends of 90° or less. The parts formed from the aluminum alloy also meet the required strength requirements. Parts formed from the aluminum alloy have a tensile strength of 50-60 kilopounds per square inch (ksi) or 345-415 Megapascals (MPa). The parts also have an elongation at break of 7%.

The parts which can be formed using the aluminum alloy include, by way of example, all wire formed parts of a vehicle, such as, door lock and release rods, hood support rods, seat belt guides, battery hold down rods, engine support and guide wires, exhaust hangers, and seat support, seat adjustment and seat structure wires.

Wire and wire assembly parts formed from the aluminum alloy composition can include sharp bends and special end treatments for connections. These parts will also satisfy predetermined manufacturer strength requirements and are capable of being manufactured using forming, threading and swaging. It has been found that for a small increase in product cost (e.g., 5-10%) a manufacturer can achieve an improvement of about 300% in weight savings by manufacturing wire and wire assembly parts using the aluminum alloy composition.

### BRIEF DESCRIPTION OF THE DRAWINGS

FIG. 1 is a perspective view of an exemplary wire part which is a vehicle door lock and release rod.

FIG. 2 is a perspective view of an exemplary wire part which is a vehicle hood support rod.

FIG. 3 is a perspective view of an exemplary wire part which is a vehicle muffler hanger.

FIG. 4 is a perspective view of an exemplary wire part which is a vehicle battery hold down.

FIG. 5 is a perspective view of an exemplary wire part which is a vehicle seat support wire.

### DETAILED DESCRIPTION OF THE INVENTION

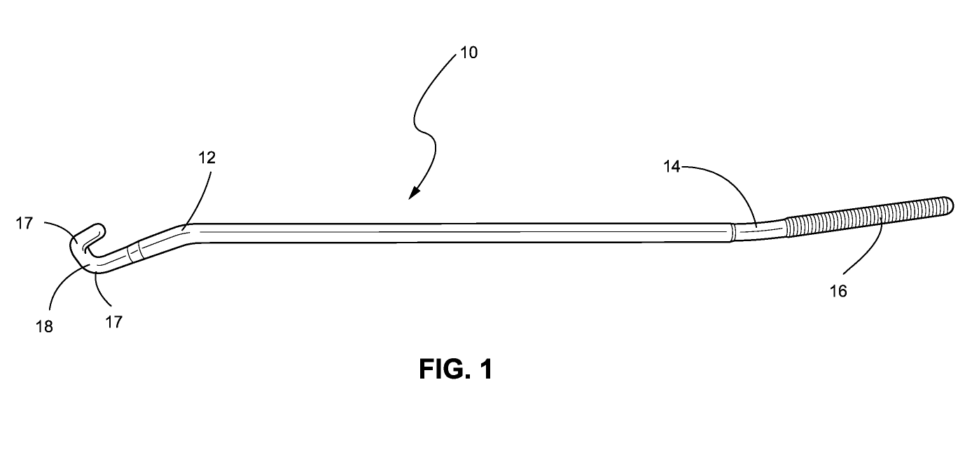

The present invention is directed to vehicle parts manufactured from a non-heat-treatable, wrought aluminum alloy, and more particularly, to wire and wire assembly parts for vehicles manufactured from the alloy. The wire and wire assembly parts are typically shaped into different forms for different applications. These parts can include, by way of example, door lock and release rods, hood support rods, seat belt guides, battery hold down rods, engine support and guide wires, exhaust hangers, and seat support, seat adjustment and seat structure wires. FIGS. 1-5 are perspective views of exemplary wire and wire assembly parts which are, respectively, a door lock and release rod 10, a hood support rod 20, a muffler hanger 30, a battery hold down rod 40 and a seat support wire 50. Typically, these parts are used in automobiles, although they might also be used in marine or aerospace vehicles.

FIG. 1 depicts one example of a door lock and release rod 10. The door lock and release rod 10 includes a formed bend 12 and two formed sharp bends 17 that allow the rod 10 to fit properly within a vehicle door in which the rod is to be used. The rod 10 also includes a special end treatment 18 for connecting the rod 10 to a latch or a connecting mechanism in the door. The two sharp bends 17 are used to form the special end treatment 18. The rod 10 further includes a swaging 14, which is a partial “necking down” of the rod, and, at an end opposite the special end treatment 18, a thread 16 rolled onto the rod 10.

The door lock and release rod 10 is formed using the disclosed non-heat-treatable, wrought aluminum alloy composition for forming wire and wire assembly parts so that the rod 10 meets certain predetermined strength and bendability requirements and so that the rod 10 is capable of being manufactured using manufacturing methods, such as forming, threading and swaging.

The vehicle parts formed from the aluminum alloy are capable of being manufactured using forming, threading and swaging. “Forming” uses stresses, like compression, tension, shear or combined stresses, to cause plastic deformation of a material to produce a required shape. “Threading” is a process of producing a screw thread. Deformative or transformative methods of producing threads include rolling and forming. “Swaging” is a process in which the dimensions of a part are altered using shaping of the aluminum alloy using localized compressive forces.

The aluminum alloy from which the parts shown in FIGS. 1-5 are made is a controlled 5000 series type of aluminum alloy in which the aluminum is alloyed primarily with magnesium. The aluminum alloy is a non-heat-treatable, wrought alloy formed predominantly from aluminum (Al) metal, and which includes silicon (Si), iron (Fe), copper (Cu), manganese (Mn), chromium (Cr), zinc (Zn), titanium (Ti), magnesium (Mg), beryllium (Be), and other elements. The aluminum alloy composition includes the following elements identified as a maximum percentage by weight, that is: 0.09% silicon (Si), 0.19% iron (Fe), 0.01% copper (Cu), 0.1%-0.15% manganese (Mn), 0.1%-0.13% chromium (Cr), 0.01% zinc (Zn), 0.06%-0.11% titanium (Ti), 4.8%-5.05% magnesium (Mg), 0.0003% beryllium (Be), 0.1% “other” predetermined elements, with each of the other predetermined elements being no more than 0.02%, and the remainder of the alloy being aluminum (Al) as the predominant metal.

The concentration of “other” predetermined elements is typically as follows: As (Arsenic)<0.005%, Ga (Gallium)<0.01%, V (Vanadium)<0.01%, Pb (Lead)<0.001%, Ni (Nickel)<0.01%, Na (Sodium)<0.0002%, and Ca (Calcium)<0.003%. It should be noted that this concentration of “other” elements can be varied.

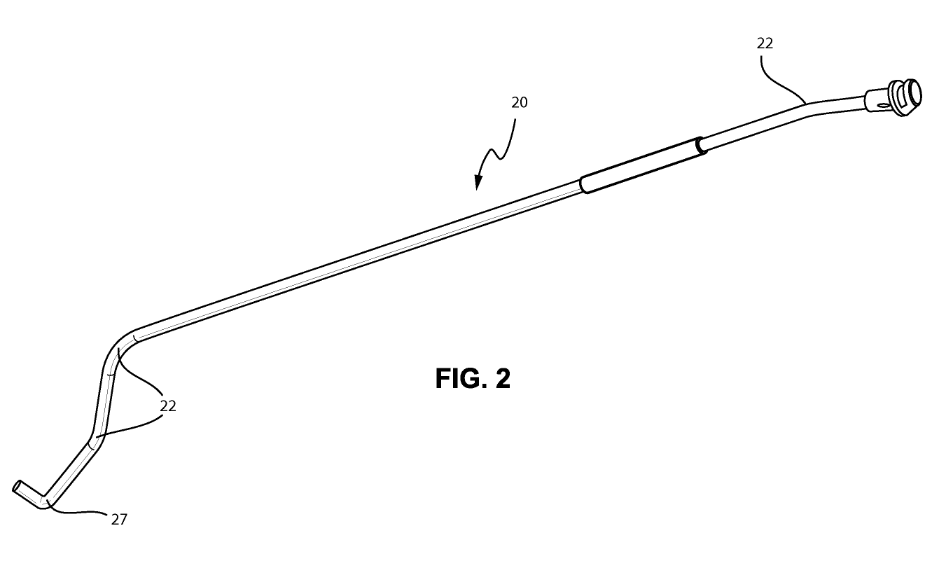

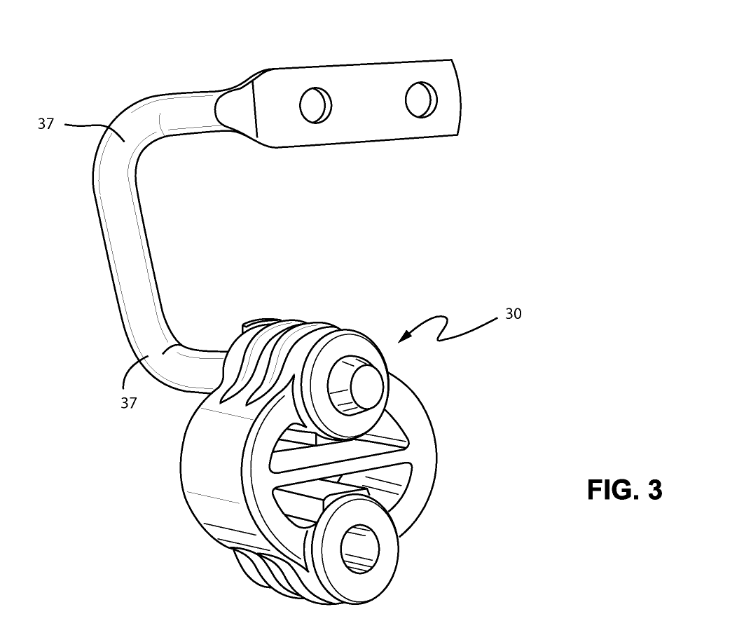

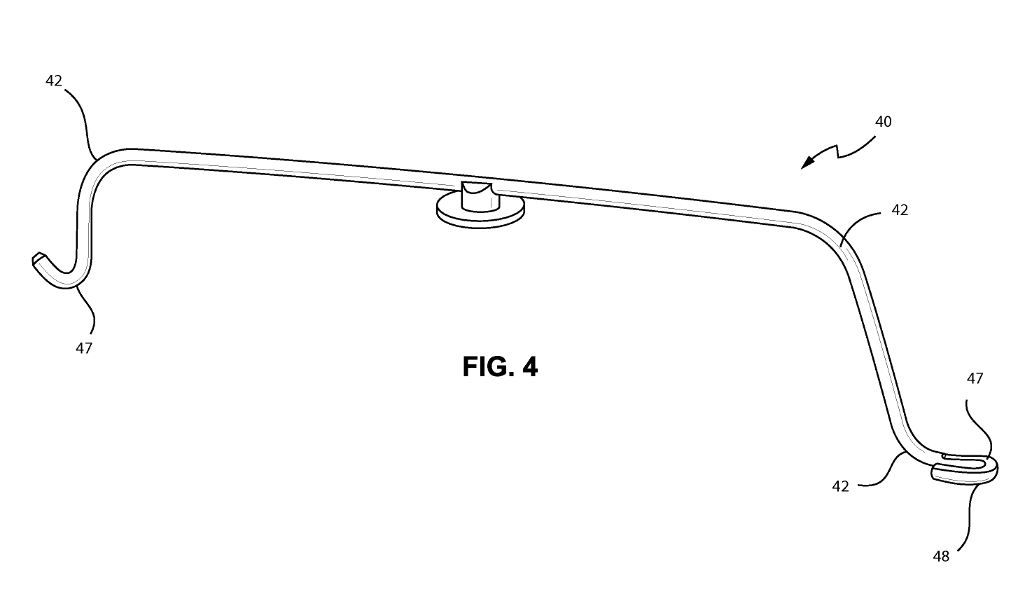

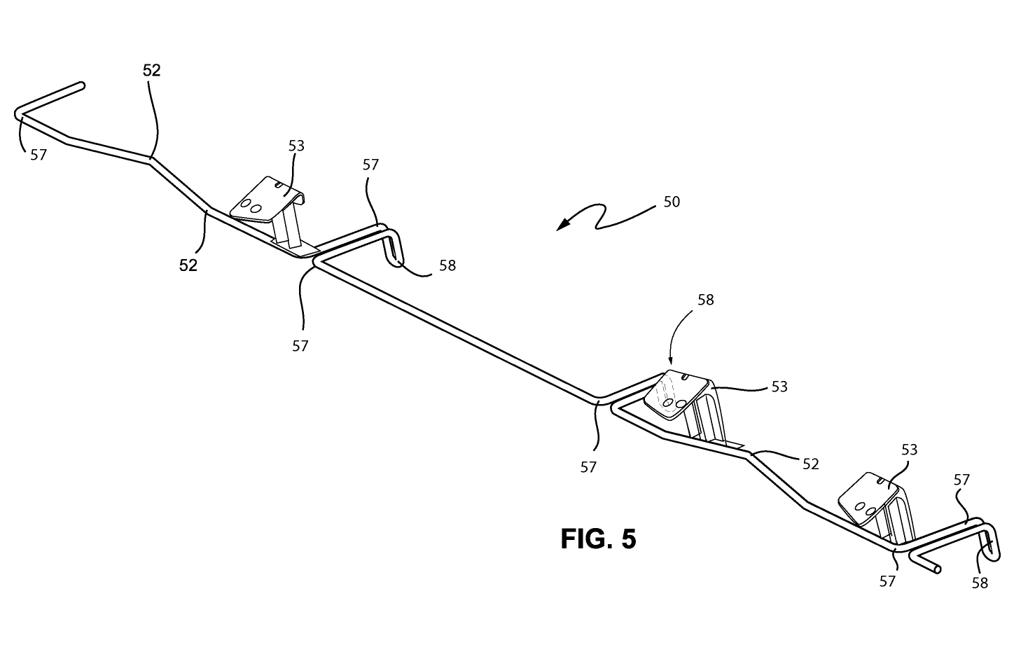

The wire and wire assembly parts made using the aluminum alloy, which are shown in FIGS. 1-5, are capable of being formed into parts having bends, and particularly, sharp bends of 90° or less. For example, the rod 10 shown in FIG. 1 includes a bend 12 and two sharp bends 17 used to form the special end treatment 18. The hood support rod 20 shown in FIG. 2 includes two bends 22 and a sharp bend 27 that leads to a protrusion that engages the hood of a vehicle to hold the hood in an upright position. The muffler hanger 30 shown in FIG. 3 includes two sharp bends 37. The battery hold down rod 40 shown in FIG. 4 includes two bends 42 to allow the rod 40 to straddle the top of a battery and two sharp bends 47, one of which engages a first bracket for holding the battery in place on a mounting plate, and a second of which is used to form a special end treatment 48 through which a bolt is inserted to engage threading in a second bracket for holding the battery in place on the mounting plate. Finally, the seat support wire 50 shown in FIG. 5 includes three bends 52 and more than half a dozen sharp bends 57, some of which are used to form special treatments 58 through which bolts are inserted to engage threading in a vehicle floor or several mounting brackets for holding the seat support wire 50, and any seat attached to it by attachment brackets 53, in place inside a vehicle.

The wire and wire assembly parts made using the aluminum alloy, which are shown in FIGS. 1-5, also meet specified strength requirements. The parts have a tensile strength of 50-60 kilopounds per square inch (ksi) or 345-415 Megapascals (MPa). “Tensile strength” is defined as the maximum stress that a material can withstand while being stretched or pulled before failing or breaking.

The wire and wire assembly parts shown in FIGS. 1-5 also have an elongation at break of ≧7%. “Elongation at break”, also known as “fracture strain”, is the ratio between changed length and initial length after breakage of a test specimen. It expresses the capability of a material to resist changes of shape without crack formation. Thus, for example, a 1 meter specimen that stretches to 1.1 meters before breaking in two has 10% elongation at break. Elongation at break is also called “Elongation”.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A vehicle part formed from a non-heat-treatable, wrought aluminum alloy, the aluminum alloy comprising the elements of aluminum (Al), magnesium (Mg), silicon (Si), iron (Fe), copper (Cu), manganese (Mn), chromium (Cr), zinc (Zn), titanium (Ti), magnesium (Mg), beryllium (Be), and other predetermined elements, the aluminum being a percentage by weight that is a majority of the alloy and the magnesium (Mg) being a percentage by weight that is less than the aluminum, but more than the remaining elements forming the aluminum alloy.

2. The vehicle part of claim 1, wherein the aluminum alloy elements are as a percentage by weight of the alloy, 0.09% silicon (Si), 0.19% iron (Fe), 0.01% copper (Cu), 0.05%-0.15% manganese (Mn), 0.1%-0.15% chromium (Cr), 0.01% zinc (Zn), 0.06%-0.11% titanium (Ti), 4.8%-5.05% magnesium (Mg), 0.0003% beryllium (Be), 0.1% other predetermined elements, with each of the other predetermined elements being no more than 0.02%, and the remainder of the alloy being aluminum (Al) as the majority metal.

3. The vehicle part of claim 2, wherein the other predetermined elements of the aluminum alloy are as a percentage by weight of the alloy, less than 0.005% arsenic (As), 0.01% gallium (Ga), less than 0.01% Vanadium (V), less than 0.001% Lead (Pb), less than 0.01% Nickel (Ni), less than 0.0002% Sodium (Na) and less than 0.003% Calcium (Ca).

4. The vehicle part of claim 2, wherein the alloy has a tensile strength of at least 50 kilopounds per square inch (ksi).

5. The vehicle part of claim 2, wherein the alloy has a tensile strength of at least 345 Megapascals (MPa).

6. The vehicle part of claim 3, wherein the alloy has a tensile strength of 50-60 kilopounds per square inch (ksi).

7. The vehicle part of claim 3, wherein the alloy has a tensile strength of 345-415 Megapascals (MPa).

8. The vehicle part of claim 2, wherein the alloy has an elongation at break of at least 7%.

9. The vehicle part of claim 3, wherein the alloy has an elongation at break equal to or greater than 7%.

10. The vehicle part of claim 2, wherein the vehicle part is a wire or wire assembly part.

11. The vehicle part of claim 10, wherein the wire or wire assembly part is formed into a predetermined shape.

12. The vehicle part of claim 10, wherein the vehicle part is an automotive part.

13. The vehicle part of claim 10, wherein the wire or wire assembly part is a door lock and release rod.

14. The vehicle part of claim 10, wherein the wire or wire assembly part is a hood support rod.

15. The vehicle part of claim 10, wherein the wire or wire assembly part is a seat belt guide.

16. The vehicle part of claim 10, wherein the wire or wire assembly part is a battery hold down rod.

17. The vehicle part of claim 10, wherein the wire or wire assembly part are engine support and guide wires.

18. The vehicle part of claim 10, wherein the wire or wire assembly part is an exhaust hanger.

19. The vehicle part of claim 10, wherein the wire or wire assembly part are seat support, seat adjustment and seat structure wires.

20. The vehicle part of claim 10, wherein the wire or wire assembly part has at least one bend.

21. The vehicle part of claim 10, wherein the wire or wire assembly part has at least one sharp bend.

22. The vehicle part of claim 21, wherein the sharp bend is a bend of 90° or less.

23. The vehicle part of claim 10, wherein the wire or wire assembly part has threading rolled onto the part.

24. The vehicle part of claim 10, wherein a predetermined part of the wire or wire assembly part swaged.

25. The vehicle part of claim 10, wherein the vehicle part is a marine part.

26. The vehicle part of claim 10, wherein the vehicle part is an aerospace part.

27. A wire or wire assembly part formed from a non-heat-treatable, wrought aluminum alloy, the aluminum alloy comprising the elements as a percentage by weight of the alloy, 0.09% silicon (Si), 0.19% iron (Fe), 0.01% copper (Cu), 0.05%-0.15% manganese (Mn), 0.1%-0.15% chromium (Cr), 0.01% zinc (Zn), 0.06%-0.11% titanium (Ti), 4.8%-5.05% magnesium (Mg), 0.0003% beryllium (Be), 0.1% other predetermined elements, and the remainder of the alloy being aluminum (Al) as the majority metal.

28. The wire or wire assembly part of claim 27, wherein the other predetermined elements of the aluminum alloy are as a percentage by weight of the alloy, less than 0.005% arsenic (As), 0.01% gallium (Ga), less than 0.01% Vanadium (V), less than 0.001% Lead (Pb), less than 0.01% Nickel (Ni), less than 0.0002% Sodium (Na) and less than 0.003% Calcium (Ca).

29. The wire or wire assembly part of claim 27, wherein the alloy has a tensile strength of 50-60 kilopounds per square inch (ksi).

30. The wire or wire assembly part of claim 27, wherein the alloy has a tensile strength of 345-415 Megapascals (MPa).

31. The wire or wire assembly part of claim 27, wherein the alloy has an elongation at break equal to or greater than 7%.

32. The wire or wire assembly part of claim 27, wherein the wire or wire assembly part is a part selected from the group consisting of door lock and release rods, hood support rods, seat belt guides, battery hold down rods, engine support and guide wires, exhaust hangers, and seat support, seat adjustment and seat structure wires.

33. The wire or wire assembly part of claim 27, wherein the wire or wire assembly part is an automotive part selected from the group consisting of door lock and release rods, hood support rods, seat belt guides, battery hold down rods, engine support and guide wires, exhaust hangers, and seat support, seat adjustment and seat structure wires.
